(19) United States
(12) Patent Application Publication
(10) Pub. No.: US 2003/0015980 A1
(43) Pub. Date: Jan. 23, 2003

(54) Gate movement arresting and locking system

(76) Inventors: Moscow K. Richmond, Inglewood, CA (US); Donald Anh Quach, Alhambra, CA (US)

Correspondence Address: J.Mark Holland & Associates, A Professional Law Corporation, 3 Civic Plaza, Suite 210, Newport Beach, CA, 92660, US

(21) Appl. No.: 09/908,015

(22) Filed: Jul. 17, 2001

(51) Int. Cl. H02P 1/00; H02P 1/22; H02P 1/40; H02P 3/00; H02P 3/20; H02P 5/00; H02P 7/00

(52) U.S. Cl. 318/280

(57) ABSTRACT

A gate movement arresting and locking system which is effective to automatically reduce the velocity of movement of a gate as it approaches an end position, but which also allows for tight closing at the end position and automatically locking at that end position. The gate movement arresting and locking system of the invention relies upon a very simple circuit arrangement which uses a pair of diodes and capacitor arrangement for controlling the movement of current and thereby operating an electromagnet in either the gate or a fixed obstruction at the closed position and which operates in conjunction with a magnet in the other of the gate or fixed obstruction.

### BACKGROUND OF THE INVENTION

1. Field of the Invention

This invention relates in general to certain new and useful improvements in gate operators with gate movement arresting systems and gate locking systems when a gate approaches its closed position of movement and, more particularly, to an improved gate operator of the type stated which operates with a relatively simple but highly effective circuit arrangement therefor.

2. Brief Description of the Related Art

In U.S. Pat. No. 5,942,867, dated Aug. 14, 1999, to Moscow K. Richmond, there is illustrated and described gate movement arresting and locking system which allows for a gate to be driven from an opened end position to a closed end position or from a closed end position to an opened end position and which slows movement of the gate shortly in advance of reaching that end position. In this way, the gate does not slam into or otherwise contact a post or other structure at the fixed end position with any appreciable force.

There have been several gate operators which have proposed the use of a microprocessor for controlling the movement of the gate by measuring the distance of movement of the gate between opened and closed positions and closed and opened positions and then moving the gate for that measured distance. However, many variables also affect the movement of the gate and, hence, these systems, while effective, do create conditions which may require adjustment from time to time. It is for that reason that Moscow K. Richmond developed the gate operator described in the aforesaid patent.

As indicated in the aforesaid U.S. patent, the impact of the gate against an abutment at a fixed end position only introduces error into tolerances, thereby increasing the possibility of impact with future opening and closing movements. In addition, the impact of the gate at these fixed end positions can ultimately result in damage to the gate and to components of the operator. At a minimum, the impact of the gate with an abutment at an end position will mar the gate, resulting in an unsightly position, not to mention the desirable noise created by the gate when engaging an abutment at a fixed end position.

U.S. Pat. No. 4,159,599, dated Jul. 3, 1979, by Moscow K. Richmond, for “Gate Opening and Closing Assembly” discloses a gate which is slidable between opened and closed positions and which uses a solenoid operated locking mechanism. U.S. Pat. No. 4,313,281, dated Feb. 2, 1882, by Moscow K. Richmond, for “Gate Opening and Closing Apparatus and Method” also discloses a positive locking mechanism for use in locking a gate when it reaches a gate closed position. U.S. Pat. No. 4,330,958, dated May 25, 1982, by Moscow K. Richmond, for “Gate Opening and Closing Assembly With Automatic Locking Means” also discloses a gate opening and closing assembly with an automatic locking means for locking the gate when it reaches a closed position.

By further reference to that aforesaid patent, it can be observed that the gate operator employs a rather complex circuit arrangement. It may be appreciated that any circuit arrangement, whether complex or simple, may require maintenance after a period of time in which dirt accumulates, electrical components burn out, and the like. However, it is also recognized that the fewer the components the longer the life span for the circuit and the less need for repair and maintenance. It would, therefore, be desirable to provide a gate operator with a relatively simple circuit arrangement.

In addition to the foregoing, it is desirable to maintain a simple circuit arrangement which will also automatically provide for a positive locking action with the gate when that gate reaches a closed position. In this way, there is not a need for a positive acting lock in which someone manually actuates that lock. Moreover, there is no need to rely upon the gate movement arms to provide a locking action through the use of 180° on-center arms. It would therefore also be desirable to provide a relatively simple circuit arrangement which not only provides for gate arresting movement but which also provides for this locking action.

It would be desirable to provide a simple and reliable circuit for temporarily repelling the movement of the gate toward that fixed end position to reduce the speed of the gate and, hence, the possibility of a hard impact with an abutment at a fixed end position. It would also be desirable for this simple and reliable circuit system to thereafter provide a positive locking of the gate at that fixed end position, precluding an authorized opening thereof.

### OBJECTS OF THE INVENTION

It is, therefore, one of the primary objects of the present invention to provide a gate movement arresting system and automatic locking system which relies upon a relatively simple circuit arrangement.

It is another object of the present invention to provide a gate movement arresting system and automatic locking system of the type stated which allows for slowing of the movement of the gate as it approaches a closed end position and opened end position and which also provides for an automatic locking of that gate as it reaches the fully closed position.

It is a further objection of the present invention to provide a gate movement arresting system and automatic locking system of the type stated which relies upon a processor utilizing a gate arresting circuit which is relatively simple in construction and primarily utilizes of pair of silicon controlled rectifiers and a resistance in combination therewith.

It is also an object of the present invention to provide a gate operator of the type stated which employs a magnetically operable switching means for initially and momentarily applying an opposition force to a gate movement toward a fixed end position and then releasing the force to reduce the amount of the impact against any abutment at the end position, and which further provides for initiation of an additional closing force when the gate reaches that fixed end position.

It is an additional object of the present invention to provide a gate operator of the type stated which is relatively economical to manufacture, and which is highly reliable in operation.

With the above and other objects in view, our invention resides in the novel features of form, construction, arrangement and combination of parts and components presently described and pointed out in the claims.

### SUMMARY OF THE INVENTION

The present invention relates in general to an improved gate operator which provides for opening and closing movement of a gate in response to a signal and which also cushions the effects of a closing or opening action at one or both of those end positions. The operator of the invention causes the generation of a force in opposition to the opening or closing movement and then the releasing of the force to reduce the amount of an impact against any abutment at the fixed end position, in the manner as taught in the aforesaid U.S. Pat. No. 5,942,867.

The operator of the invention further provides for a gradual but fairly rapid reduction of that repelling force and with the addition of a force tending to further move the gate toward that fixed end position. The operator finally causes a locking action of the gate when at that fixed end position precluding unauthorized opening of the gate.

The gate operator of the invention relies upon the provision of a magnetic switching and controlling assembly which generates a repelling action against movement of a gate to a fixed end position shortly in advance of that end position and the additional force to move the gate to the closed end position and further provides a positive locking action. The magnetically operable switching and controlling means preferably comprises a permanent magnet on one of the fixed members at an end position and an electromagnet on the other of the gate or fixed member at that end position. Preferably, the electromagnet is mounted on the gate, although the alternate arrangement could be employed.

The present invention can provide for the same action at both the open and the closed positions or only at one of those positions. In the case where the gate may abut against a fixed member at the gate opened position and the gate closed position, it would be desirable to provide a permanent magnet at each of those fixed end positions with electromagnets on the gate, or otherwise, electromagnets at the fixed end positions with a permanent magnet on the gate.

The gate operator of the present invention preferably reduces the repelling magnetic action fairly rapidly as the gate approaches and is in near proximity to that fixed end position. At that point in time, the movement of the gate ha slowed substantially and the operator will thereupon provide a slight boast by creating a positive magnet force causing movement of the gate toward that fixed end position. After the gate does reach the fixed end position, a processor in the gate operator will increase the magnetic force between the permanent magnet and the electromagnet in order to create a positive magnet locking action.

The operator of the invention relies upon the principles described in now issued U.S. Pat. No. 5,942,867, dated Aug. 24, 1999, and in which Moscow K. Richmond is the inventor thereof. In accordance with the operator disclosed in that patent, an electromagnet is mounted in one of a gate or a post at a fixed end position and a permanent magnet is mounted in the other of the post or gate. A circuit is employed to control the movement of that gate.

The gate operator described and claimed in that aforesaid U.S. Pat. No. 5,942,867 has been found to be highly effective and is efficient in operation. However, it would be desirable to provide a gate operator with a more simplified circuit arrangement. The gate operator of the present invention, at least with respect to that portion of the circuit which arrests movement of the gate and automatically provides for locking of the gate, is relatively simple in construction and in operation and employs very few electrical components therefor. As a result, it provides a superior operator.

The operator of the present invention relies upon a pair of current controlling elements, which act as switcher, preferably in the form of silicon controlled rectifiers, located in circuit arrangement with respect to one another to allow or block current flow to a core of an electromagnet and a resister connected to the output of those diodes or silicon controlled rectifiers. Each rectifier is arranged so that it can pass current directly to an electromagnet, but only one can be active in this way at any time. The second rectifier is also located so that it connects to the input to the first rectifier and can energize the electromagnet when the action of the first silicon controlled rectifier is off.

The term “gate” as used herein is used in a broad sense to encompass any member which extends across an access opening. Thus, the term “gate” is used in a broad sense to include doors and the like. Moreover, the gate operator of the invention is applicable to so-called “swinging gates” as well as so-called “sliding gates”. In addition, it can be used with overhead garage doors and the like.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of a gate operator constructed in accordance with and embodying the present invention and shown in relation to a swingable gate;

FIG. 2 is a circuit diagram showing one form of processor which may be used in accordance with the present invention; and

FIG. 3 is a schematic circuit view showing one form of gate movement arresting and locking circuit forming part of the processor used in the operator of the present invention.

### DETAILED DESCRIPTION OF PREFERRED EMBODIMENTS

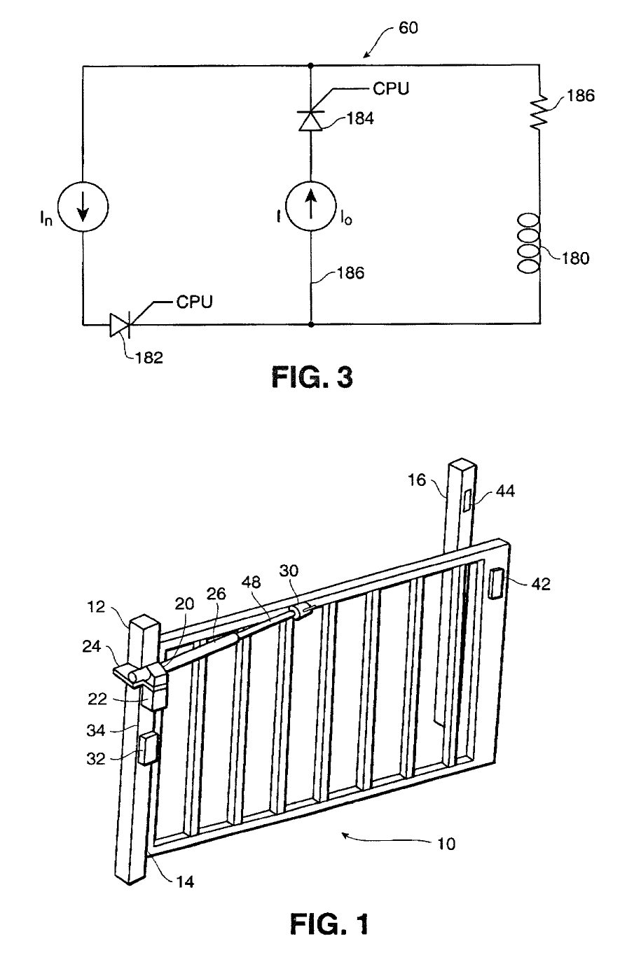

Referring now in more detail and by reference characters to the drawings which illustrate a preferred embodiment of the present invention, FIG. 1 shows a perspective view of a gate 10 which is hingedly rotatable about a vertical axis at one of its ends, typically referred to in the art as a so-called “swing gate” or “swinging gate”. In the embodiment of the invention as illustrated in FIG. 1, the swinging gate 10 is hingedly mounted to a fixed post 12, typically through hinges 14.

In the embodiment of the invention as shown in FIG. 1, the gate is movable between a closed position, that is, where the gate extends between the fixed post 12 and an opposite post 16, thereby closing an access opening. However, the swinging gate 10 is also shiftable through an angle of approximately ninety degrees to a fully opened position. In this case, a fixed wall or abutment 18 is shown adjacent that fully opened position.

Gate arrangements of this type illustrated in FIG. 1 are often used with security apartment buildings and similar commercial establishments, along with dwelling structures. The access openings permit passage of either people or vehicles, and the gate is typically shifted from the closed to the open position, for such access. Generally, many commercially available prior art gate operators employ a radio frequency receiver-transmitter system, such that the party desiring to open the gate will actuate the transmitter to generate a signal which will, in turn, cause a receiver to energize a motor for shifting the gate. Other systems rely upon a magnetically operated key card or, for that matter, an actual key in which to energize the motor for opening and closing the gate. In this respect, the gate operator of the present invention can be used with any of these type of conventional inputs.

The gate operator of the present invention comprises a small drive mechanism 22 which is mounted on the fixed post 12, and typically on a plate 24 extending outwardly therefrom, as shown in to FIG. 1. The small drive mechanism 22, however, must be pivotally or rotatably mounted on the plate 24 or otherwise pivotally or rotatably mounted directly to the fixed post 12.

The actual drive mechanism 22 is more fully illustrated and described in U.S. Pat. No. 5,804,938, dated Sep. 8, 1998, by Moscow K. Richmond. A drive motor, not shown in FIG. 1, is located in the drive mechanism 22. The motor is vertically arranged and mounted on the upper end of the motor is an actuating arm 26. The gear train causing movement of the arm 26 is not illustrated or described inasmuch as any type of conventional gear arrangement could be employed in order to operate the actuating arm 26. Extensible and retractable within the housing of the actuating arm 26 is a powered extensible and retractable arm 28. The arm 28 is powered for extension outwardly from the housing and retraction therein.

At its outer end, the extensible and retractable arm 28 is provided with a coupling 30 for securement to the swinging gate 10, in the manner as shown in FIG. 1.

At its closed position against the post 16, the gate could be provided with a locking mechanism if desired which will open or close in response to a proper gate open or gate close signal. One such type of locking mechanism which can be used for automatically locking the gate in the closed position is taught in issued U.S. Pat. No. 4,916,860, dated Apr. 17, 1990, by Moscow K. Richmond, et al.

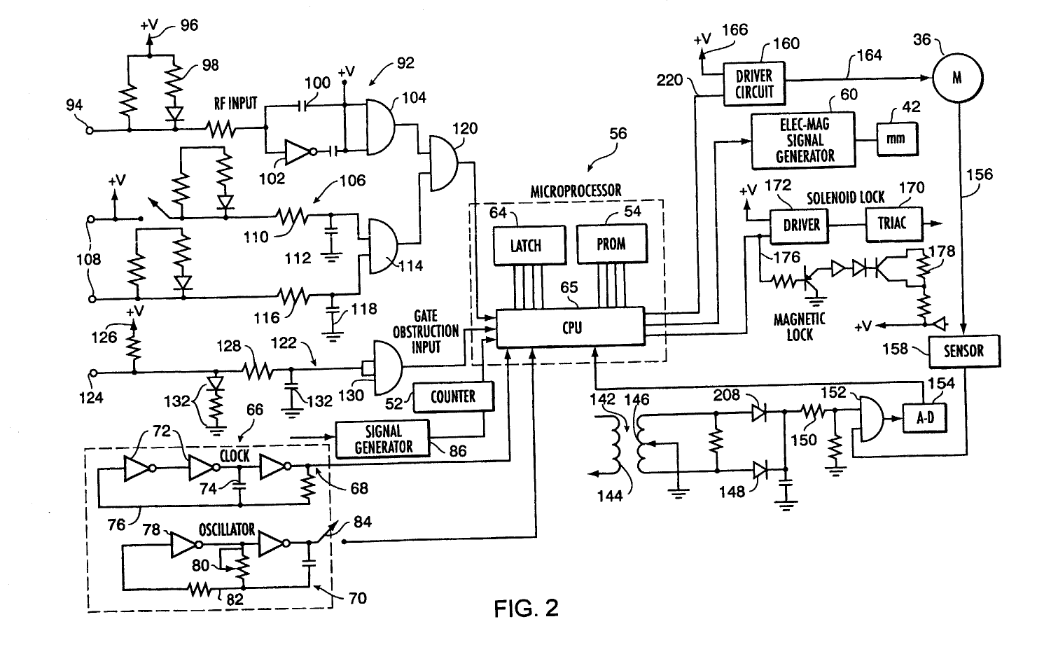

A control circuit is used in conjunction with the small drive mechanism 22 and is electrically connected to the aforesaid electric motor. The control circuit is more fully illustrated in FIG. 2 and may be suitably contained within a control housing 32 also mounted on the fixed post 12, in the manner as shown, and electrically connected to the motor housing through a conduit 34. In this regard, the control housing is not necessarily required to be located in close proximity to the small drive mechanism 22, although it is desirable to do so.

The control circuit, more fully illustrated in FIG. 2, generally opens and closes the gate on an automated basis. The control circuit is designed to measure the amount of movement of the gate from the closed position to the open position and thereafter move the gate on each subsequent occasion for this measured distance. In like manner, the control circuit will measure the movement of the gate from the opened position back to the closed position and thereafter control the movement of the gate for this measured distance on each subsequent movement from the opened to the closed position.

It should be understood that an operator, such as a ground mounted operator, could be provided, such that the drive housing would be mounted on a fixed structure, such as a wall or a post. In like manner, other means for connecting the drive motor to the gate 10 could also be employed and it is not necessary to rely upon the drive structure as shown.

The present invention also provides a magnetic switching and controlling assembly which allows for the control or movement of the gate 10 between the opened and closed positions. This magnetic switching and control assembly comprises an electromagnet 42 mounted on the gate 10 in the manner as shown. The electromagnet 42 is preferably exposed on both faces of the gate in the embodiment as illustrated where at least the post 16 is located at the closed end position. However, a separate electromagnet 42 could be located on each of the opposite sides of the gate. The electromagnet 42 cooperates with a permanent or fixed magnet 44 located on each of the posts 18 and 20. However, it should be understood that the electromagnet could be reversed in position with the permanent magnet, such that the electromagnet is mounted on the post 16 and a permanent magnet is located in the gate 10. Moreover, it should also be understood that all of the magnets could be electromagnets if desired.

It should be understood that this magnetic switching and controlling assembly which provides for a reduction of force of an impact can be incorporated in new gate operators or, otherwise, it may be incorporated in existing operators. Preferably, it is desirable for use in operators in which the operator measures the distance of movement between the closed and opened positions and only moves the gate for that measured distance. However, it can be used effectively in any operator. Even with those operators which do not provide for measurement of the distance and concomitant movement of the gate for that measured distance, the magnetic switching and controlling assembly of the present invention is still highly effective, in that it reduces the force of an impact at those fixed end positions.

The operator of the present invention is highly effective, in that it initially and momentarily applies a magnetic force in opposition to a movement of the gate in order to substantially cause movement of the gate toward that fixed end position, and only shortly in advance of the end position. Thus, when the gate is being moved to a closed position, the operator will provide a driving action for driving gate at a relatively constant speed from the opened position to the closed position. Shortly in advance of the closed position, the operator will energize the electromagnet causing the repelling force. This will, in turn, cause the gate to substantially slow its movement and thereby reduce the force of any impact.

However, the gate may be arrested in its movement substantially so that it would unduly slow to a complete closing movement. As a result, the processor then generates an additional magnetic force assisting in this closing movement, that is, moving the gate to the end position toward which it was traveling. That force is then released as the gate reaches the closed position. Thereafter, a positive locking action is provided at the closed position by creating a relatively strong magnetic force between the permanent magnet and the electromagnet.

FIG. 2 illustrates a more detailed circuit schematic which forms part of the operator of the present invention. A microprocessor 56 comprises a programmable read only memory 54 as well as a latching circuit 64 and a central processing unit 65. The microprocessor 56 is operated by a master clock circuit 66, a pulse generating circuit 68 and an adjustable oscillator 70. The clock pulse generating circuit 68 includes a plurality of inverting amplifiers 72, in the manner as illustrated, along with a capacitor 74 connected across a feedback line 76 between the inverting amplifiers 72. The oscillator 70 also comprises a pair of inverting amplifiers 78 with an adjustable resistor 80 connected in a feedback loop 82 across the amplifiers 78. A switch 84 may be provided for turning the oscillator off and on. The master clocking circuit 66 provides the necessary controlled timing for the operation of the entire control unit 56. In addition, the adjustable oscillator 70 controls the rate of movement of the gate during opening and closing.

A signal generator 86 receives an input from a movement measuring member as, for example, a magnetic sensor which measure the degree of rotations of a rotatable shaft and which thereupon generates a signal representative of a degree of rotation of that shaft and, hence, movement of the gate. This type of magnetic pulse generating member is more fully described in U.S. Pat. No. 4,230,179, dated Jul. 27, 1993. The signal generator 8 receives this input over an input line 88 and generates electrical signals responding to the amount of rotation of that rotatable element. This signal is then introduced into the counter 52 and, more specifically, into the central processing unit 65 for determining the distance of movement of the gate. In this case, the counter 52 will determine the number of counts of rotation of the drive shaft and introduce that number of counts into the central processing unit 65 of the microprocessor 56. In this way, the distance of movement of the gate is known and the opening and closing movement of the gate can be controlled on all subsequent opening and closing movements.

The microprocessor 56 also receives an input from a radio frequency input circuit 92, as illustrated in FIG. 2. This circuit would include a radio frequency sensor 94 connected to a voltage supply 96 forming part of or connected to a resistive network 98. The output of the sensor 94 is introduced through a filtering capacitor 100 and an inverting amplifier 102 into an And gate 104.

The microprocessor 56 also receives a key input from a key input circuit 106 and which also has a key operated mechanism identified by a pair of inputs 108. One of the inputs 108 is connected to a voltage supply, as illustrated. This same input is connected through a coupling resistor 110 and grounded capacitor 112 to an And gate 114. The other of the inputs 108 is also connected through a resistor 116 and a capacitor 118 to the And gate 114. These two inputs are added in the And gate 114 and the output of the key operated circuit 106 is added with the output of the radio frequency input circuit in another And gate 120. The output of this And gate 120 is thereupon introduced into the central processing unit 65.

The control unit of the present invention also comprises a gate obstruction input circuit 122. In this case, a voltage rise, as a result of a back EMF may be generated in the armature of the motor which causes a signal designated by the input 124. This signal is connected to a positive voltage source 126 and is introduced through a coupling resistor 128 into a pair of inputs of an And gate 130. A grounded capacitor 132 and diode resistor arrangement are also connected to the input of the And gate 130.

A current sensing transformer 142 is provided for detecting a current rise signal in the field winding of the motor and comprises a primary winding 144 and a secondary winding 146, the latter of which has a grounded center tap. Connected to each of the terminals of the secondary winding 146 are a pair of diodes 148. A voltage dividing network 150 is also connected to the output of one of the diodes 148 and is, in turn, connected to an and gate 152 and which is introduced into an analog to digital converter 154, also as best shown in FIG. 2. The motor 36 may have an output feedback signal over a feedback line 156 introduced into a current sensor 158 and which is, in turn, also introduced into the And gate 152. In this way, the transformer 142 can direct a current rise in the field winding of the motor. This would be due to the fact that, as the gate reaches the closed position, the electromagnet would be generating a magnetic field which is of the same polarity as that of the fixed magnet 44, thereby repelling the gate. This would, in turn, cause a current rise in the field winding of the motor which would be sensed by the sensing transformer 142. In like manner, a feedback signal from the motor through the line 156 and current sensor 158 could also be added to that signal from the current sensing transformer 142 and this information provided to the central processing unit 65.

The central processing unit would thereupon cause a cessation of or otherwise a reduction of driving action to the drive motor through a driver circuit 160 receiving an output of the central processing unit 65. As this occurs, either the driving action can be reduced or eliminated, as aforesaid. The feedback line 156 and the current sensor 158 are not necessary in accordance with the present invention, but can be used in the manner as previously described.

As indicated previously, the opposition force is generated only as the gate approaches the end position. When the gate reaches the fully closed position, the opposition force is stopped. The central processing unit will recognize when the gate has reached that fully closed position, since is measures the distance of movement of the gate. At that time, re-energization of the electromagnetic signal generator 60 could cause energization of the electromagnet 42.

The driving circuit 160 is connected to the motor through a driving signal line 164 and to a positive driving source 166, also as best shown in FIG. 2 of the drawings.

The electromagnetic signal generator 60 can be operable with a very simple circuit arrangement of the type illustrated in FIG. 3 of the drawings. By reference to FIG. 3, it can be observed that the electromagnet 42 would have a coil 180 which will generate the flux for creating a magnetic polarity as a current, such as a current flux, which passes through the coil 180. In like manner, on the opposite side of the coil, the output current is designated by reference letters Iₒ.

The electromagnetic field signal generator 60 further comprises a pair of silicon controlled rectifiers 182 and 184 which are connected, such that the silicon controlled rectifier 182 has its output connected to the input of the silicon controlled rectifier 184 and also independently thereof to the coil 180. Moreover, it can be observed that each of the rectifiers 182 and 184 are controlled by and receive a control signal from the central processing unit 65.

The silicon controlled rectifier 184 operates in opposition to the rectifier 182. Thus, when one of the silicon controlled rectifiers, such as the rectifier 182, is conducting, current flows through that loop including the coil 180 and the resister 186. Thus, current will flow directly through the coil 180 and generally in a counter-clockwise direction with respect to FIG. 3. When the silicon controlled rectifier 182 is bias to the off position, and the silicon controlled rectifier 184 is conducting, then current flow will occur through the rectifier 184 to the resister 186 and the coil 180, generally in a clockwise direction, reference being made to FIG. 3.

In essence, when the silicon controlled rectifier 182 is conducting, there is an active “high” signal or “one” signal to the CPU output of the rectifier 184, and current is passing through the coil via the silicon controlled rectifier 184. The same holds true when the silicon controlled rectifier 182 is biased to a high or “one” position. However, only one silicon controlled rectifier will be conducting at any point in time. Nevertheless, both can be off or not conducting at the same time. Thus, when both are conducting, current flows through a loop including the conductor 186. However, when the silicon controlled rectifier 184 is biased to an off position, then current from the silicon controlled rectifier 182 will pass directly through the coil 180.

When an active high or “1” signal is applied to the CPU input of the silicon controlled rectifier 182, it will allow a current flow therethrough. However, if a zero input or active low is applied to the CPU signal line of the rectifier 182, it will be biased off and no current will pass therethrough. The electromagnetic signal generator 60 will cause generation of the input current Iₙ. When that current is applied to the silicon controlled rectifier 182, such that the latter is non-conducting, the output current Iₒ will make a complete loop through the coil 180. As the current makes a complete loop through the coil 180, the electromagnet 44 will be in a first polarity state, such as a north polarity state.

When the silicon controlled rectifier 182 is conducting, the current Iₙ passing the rectifier 182 will effectively bypass the coil. In effect, it can be seen that when the silicon controlled rectifier 184 is conducting, current Iₒ will flow through the coil in the opposite direction. The resistance 186 is an internal resistance of the coil 180.

However, when the rectifier 184 is not conducting, current flow will pass through the coil 180 and thereby form a complete loop with the rectifier 182. In this way, the polarity of the coil 180 will be biased to a different state as, for example, a south polarity state.

This simple circuit switching arrangement has been found to be highly effective, in that it precisely causes the switching which is needed. Moreover, by pulsing the coil very quickly, it is possible to effectively control the amount of the electromagnetic force generated and, hence, control the closing speed of the gate. Moreover, it can be observed that by controlling the current applied to the coil, it is possible to control the polarity and, hence, the repellant to create a repelling action or permit a closing action, as aforesaid.

This very simple circuit arrangement allows the electromagnetic signal generator 60 to create the desired repelling and locking action, as may be desired. Moreover, it is very inexpensive to produce and the component parts are quite inexpensive and, thus, the circuit is not only inexpensive to produce, but it is also highly reliable in operation.

It is also possible to provide a solenoid locking circuit for achieving a positive lock when the gate reaches the fully closed position or otherwise the fully opened position. Actually, it is only necessary to provide this positive locking action when the gate reaches the fully closed position. The locking action could be that which is described in U.S. Pat. No. 5,137,809 in which a signal is generated to cause the motor to operate in such manner that it forces movement of the gate to the closed position in the event of an opposition force applied to the gate. In other words, the motor will force the gate to the closed position against the action of someone attempting to move the gate to the opened position. The other type of locking action which may exist is that of initiating a locking action signal to a locking solenoid (not shown) causing a locking pin to move into a locked position.

If desired, a solenoid locking circuit 170 may be employed, as shown in FIG. 2. This locking circuit will include a driver 172 operating in conjunction with a triac 174 and an output from the central processing unit 65 is introduced into a magnetic lock 176 having an output to a lock input circuit 178, a shown. In this way, if desired, a positive magnetic lock can also be provided at the gate for fully locking the gate in the fully closed position.

Thus, there has been illustrated and described a unique and novel gate operator as well as an improvement in gate operator sand also a method for moving a gate between open and closed end positions and which allows for cushioning the effect of any impact by the gate against an abutment or other fixed member at an open or closed position. The present invention thereby fulfills all of the advantages and objects which have been sought therefor. It should be understood that many changes, modifications, variations and other uses and applications will become apparent to those skilled in the art after considering this specification and the accompanying drawings. Therefore, any and all such changes, modifications, variations and other uses and applications which do not depart from the spirit and scope of the invention are deemed to be covered by the invention.

Having thus described the invention, what we desire to claim and secure by Letters Patent is:

1. In gate operator which provides for opening and closing movement of a gate in response to a signal and which cushions the effect of the closing action at a closed fixed end position, an improvement comprising:
a) magnetically operable switching and control means at the closed fixed end position for initially and momentarily applying an opposition force to the movement of the gate in response to said signal and in opposition to the closing movement and then releasing the opposition force to reduce the amount of an impact against any abutment at the closed fixed end position, said switching and control means comprising an electromagnet and a pair of current controlling members which selectively control flow of current to said electromagnet.

2. The improvement in the gate operator of claim 1 further characterized in that said improvement comprises a processing means connected to said switching and control means to control operation of said switching and control means.

3. The improvement in the gate operator of claim 1 further characterized in that said improvement comprises driving means for causing an opening movement and a closing movement of the gate in response to an external command.

4. The improvement in the gate operator of claim 1 further characterized in that said current controlling members are diode acting switching elements which selectively allow for and block flow of current therethrough.

5. The improvement in the gate operator of claim 4 further characterized in that said current controlling members are silicon controlled rectifiers.

6. The improvement in the gate operator of claim 1 further characterized in that said magnetically operable switching and control means is an electromagnetically operable switching and control means.

7. The improvement in the gate operator of claim 1 further characterized in that said magnetically operable switching and control means is comprised of magnetic means on said gate and magnetic means aligned therewith on a fixed member at said closed end position.

8. The improvement in the gate operator of claim 7 further characterized in that said magnetically operable switching and control means comprises:
a) a permanent magnet located at one of said gate or fixed member at said end position and an electromagnet operable in response to said signal located at the other of said gate or fixed member at said fixed end position; and
b) processing means which operation of said electromagnet to cause a momentary energization of same and thereby generate a momentary repelling action as said gate approaches and is near said fixed end position, and said processing means causes a reduction of said repelling action as said gate is very close to said fixed end position.

9. The gate operator of claim 8 further characterized in that said processing means causes a locking action using the magnetically operable switching means as the gate reaches that end position.

10. An improvement in gate operators of the type which provides for opening and closing movement of a gate from an opened end position to a closed end position and which also controls movement therebetween with a drive motor causing the opening and closing movement in response to an external command, said improvement comprising:
a) a pair of magnetically operable electronic control elements successively operating in unison and in opposition to one another to control movement of the gate to the closed position.

11. The improvement in gate operators of claim 10 further characterized in that said control elements are current switching elements which switch current off and on.

12. The improvement in gate operators o claim 11 further characterized in that said control elements are silicon controlled rectifiers.

13. An improvement in gate operators of claim 10 further characterized in that said control elements operate in such manner as to initially and momentarily applying an opposition force to the gate and in opposition to the closing movement and then releasing the force to reduce the amount of an impact against any abutment at that end position.

14. The improvement in the gate operator of claim 10 further characterized in that said control elements have outputs connected in common.

15. The improvement in the gate operator of claim 10 further characterized in that said magnetically operable switching elements operate in conjunction with a magnetic means on said gate and a magnetic means aligned therewith on an abutment member at one of said end positions.

16. The improvement in the gate operator of claim 15 further characterized in that a permanent magnet is located at one of said gate or abutment at said end position and an electromagnet is operable in response to said signal located at the other end of said gate or abutment at said fixed end position.

17. A method of opening and closing a gate between a gate opened fixed end position and a gate closed fixed end position and also reducing impact with an abutment at least at said closed end position, said method comprises:
a) selectively controlling current flow with a pair of current controlling elements to thereby momentarily energize an electromagnetic means at one of said gate or said fixed end position operating in conjunction with a magnetic means at the other of said gate or fixed end position to create a force in opposition to movement of the gate to that fixed end position shortly in advance of that fixed end position.

18. The method of opening and closing a gate of claim 17 further characterized in that the method comprises releasing that force to reduce the amount of an impact of the gate against any abutment at that end position.

19. The method of claim 18 further characterized in that said method comprises causing a locking action of the gate at that fixed end position when the gate reaches the fixed end position.
